(19) United States
(12) Patent Application Publication
(10) Pub. No.: US 2024/0405433 A1
(43) Pub. Date: Dec. 5, 2024

(54) ANTENNA MODULES AND COMMUNICATION DEVICES

(71) Applicant: Intel Corporation, Santa Clara, CA (US)

(72) Inventors: Telesphor Kamgaing, Chandler, AZ (US); Georg Seidemann, Landshut (DE); Harald Gossner, Riemerling (DE); Thomas Wagner, Regelsbach (DE); Bernd Waidhas, Pettendorf (DE); Tae Young Yang, Hillsboro, OR (US)

(73) Assignee: Intel Corporation, Santa Clara, CA (US)

(21) Appl. No.: 18/328,107

(22) Filed: Jun. 2, 2023

(51) Int. Cl. H01Q 9/04; H01Q 1/22

(52) U.S. Cl. CPC H01Q 9/0414; H01Q 1/2283

(57) ABSTRACT

Disclosed herein are antenna modules, electronic assemblies, and communication devices. An example antenna module includes an IC component, an antenna patch support over a face of the IC component, and a stack of antenna patches vertically arranged at least partially above one another, where a first antenna patch of the stack is an antenna patch closest to the IC component, and a second antenna patch of the stack is an antenna patch closest to the first antenna patch. The first antenna patch is on the face of the IC component while the second and further antenna patches of the stack are on or in the antenna patch support and are electrically isolated from all electrically conductive material pathways in the antenna patch support and in the IC component.

### BACKGROUND

Wireless communication devices, such as handheld computing devices and wireless access points, include antennas. The frequencies over which communication may occur may depend on the shape and arrangement of the antennas, among other factors.

### BRIEF DESCRIPTION OF THE DRAWINGS

Embodiments will be readily understood by the following detailed description in conjunction with the accompanying drawings.

FIGS. 1-6 are side, cross-sectional views of example antenna modules, in accordance with various embodiments.

FIGS. 7-8 are side, cross-sectional views of example integrated circuit (IC) packages in which antenna modules could be implemented, in accordance with various embodiments.

FIG. 9 is a top-down view of an example IC package with a plurality of antenna stacks, in accordance with various embodiments.

FIG. 10 is a perspective view of a handheld communication device including an IC package with one or more antenna modules, in accordance with various embodiments.

FIG. 11 is a perspective view of a laptop communication device including multiple IC packages with one or more antenna modules, in accordance with various embodiments.

FIG. 12 is a top view of a wafer and dies that may be included in an antenna module, in accordance with any of the embodiments disclosed herein.

FIG. 13 is a side, cross-sectional view of an IC device that may be included in an antenna module, in accordance with any of the embodiments disclosed herein.

FIG. 14 is a side, cross-sectional view of an IC device assembly that may include one or more antenna modules, in accordance with any of the embodiments disclosed herein.

FIG. 15 is a block diagram of an example communication device that may include one or more antenna modules, in accordance with any of the embodiments disclosed herein.

FIG. 16 is a block diagram of an example radio frequency (RF) device that may include one or more antenna modules, in accordance with any of the embodiments disclosed herein.

### DETAILED DESCRIPTION

The systems, methods and devices of this disclosure each have several innovative aspects, no single one of which is solely responsible for all of the desirable attributes disclosed herein. Details of one or more implementations of the subject matter described in this specification are set forth in the description below and the accompanying drawings.

For purposes of illustrating antenna modules proposed herein, it might be useful to first understand phenomena that may come into play in some systems where antenna modules may be used. The following foundational information may be viewed as a basis from which the present disclosure may be properly explained. Such information is offered for purposes of explanation only and, accordingly, should not be construed in any way to limit the broad scope of the present disclosure and its potential applications.

Antenna dimensions are inversely proportional to the frequency of operation. Therefore, as the frequency of operation of wireless communication devices increases into millimeter wave, sub-Terahertz (THz), and THz regions, antenna dimensions become small enough to consider integration of antenna arrays within IC packages and on die. In fact, antenna integration in a single package with one or more IC components used to control operation of the antennas (e.g., IC dies comprising RF transceiver circuitry) is a critical component of millimeter wave, sub-THz, and THz systems. At these frequencies, the output power of semiconductor devices (e.g., transistors) used in the IC components decreases substantially, making it critical to minimize various losses. One component that contributes to the losses is signal reflection due to the mismatch at the transition between an antenna substrate with antenna units and an IC component with control circuitry to control operation of the antenna units and/or with electrically conductive pathways for providing signals for controlling operation of the antenna units.

Disclosed herein are antenna modules, electronic assemblies, and communication devices. An example antenna module may include an IC component, an antenna patch support over a face of the IC component, and a stack of antenna patches vertically arranged at least partially above one another, where a first antenna patch of the stack is an antenna patch closest to the IC component, and a second antenna patch of the stack is an antenna patch closest to the first antenna patch (i.e., the second antenna patch is an antenna patch second closest to the IC component). In some embodiments, the IC component may be an IC die comprising active circuitry, e.g., RF transceiver circuitry for controlling operation of the antenna module and further comprising electrically conductive material pathways (e.g., conductive lines, conductive vias, various conductive contacts such as pads, and various interconnects such as solder balls) for providing signals, ground, and/or power to/from at least one of the antenna patches of the stack. In other embodiments, the IC component may be an antenna feed substrate or any other IC component that includes electrically conductive material pathways for providing signals, ground, and/or power to/from at least one of the antenna patches of the stack, but no active circuitry. In such an antenna module, the first antenna patch is on the face of the IC component while the second and further antenna patches of the stack are on or in the antenna patch support (i.e., not in or on the IC component) and are electrically isolated from all electrically conductive material pathways in the antenna patch support and in the IC component. This is in sharp contrast to some conventional implementations where a first antenna patch of a stack is implemented on or in an antenna patch support and electrically connected, e.g., via a conductive via and/or an interconnect to electrically conductive material pathways in an IC component underneath. Because the first antenna patch of the stack is on the face of the IC component, it may be in contact with (i.e., electrically connected to) one or more electrically conductive material pathways of the IC component so that signals may be provided to/from the first antenna patch. The second and further antenna patches of the stack are not electrically connected to any electrical conductors but are capacitively coupled between one another and the first antenna patch (i.e., there is no physical connection using an electrical conductor between different antenna patches of the stack; the signal may be coupled from the first antenna patch to the second antenna patch capacitively, and then coupled to the subsequent layers of the antenna patches using the same mechanism). Because all other antenna patches of the stack are above the IC component and electrically isolated from all electrically conductive material pathways in the antenna patch support and in the IC component, these antenna patches may be arranged so that no electrically conductive materials (in the form of electrically conductive material pathways) may be present between adjacent antenna patches of the stack and between the first and second antenna patches, thus reducing or eliminating losses due to signal reflection due to the mismatch at the transition between the antenna patch support and the IC component.

Various ones of the antenna modules disclosed herein may exhibit improved performance to enable millimeter wave, sub-THz, and THz operation in mobile devices and other electronic device environments. For example, the antenna modules disclosed herein may enable the antenna substrates disclosed herein to achieve broad bandwidth operation with high return loss and high gain. In another examples, the low cost, high yield techniques and designs disclosed herein may allow improving impedance bandwidth and radiation efficiency over the operational bandwidth. Further various ones of the antenna modules disclosed herein may exhibit little to no warpage during operation or installation, ease of assembly, low cost, fast time to market, and/or good mechanical handling. The antenna modules disclosed herein may be advantageously included in mobile devices, base stations, access points, routers, backhaul communication links, and other communication devices.

In the following detailed description, reference is made to the accompanying drawings that form a part hereof wherein like numerals designate like parts throughout, and in which is shown, by way of illustration, embodiments that may be practiced. It is to be understood that other embodiments may be utilized, and structural or logical changes may be made, without departing from the scope of the present disclosure. Therefore, the following detailed description is not to be taken in a limiting sense.

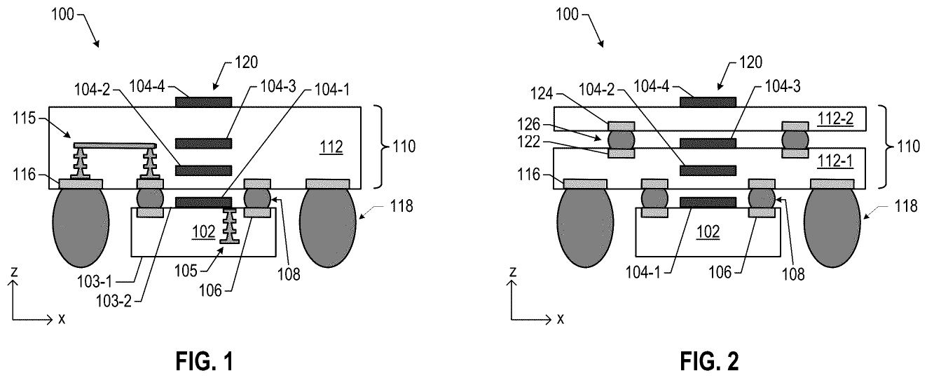

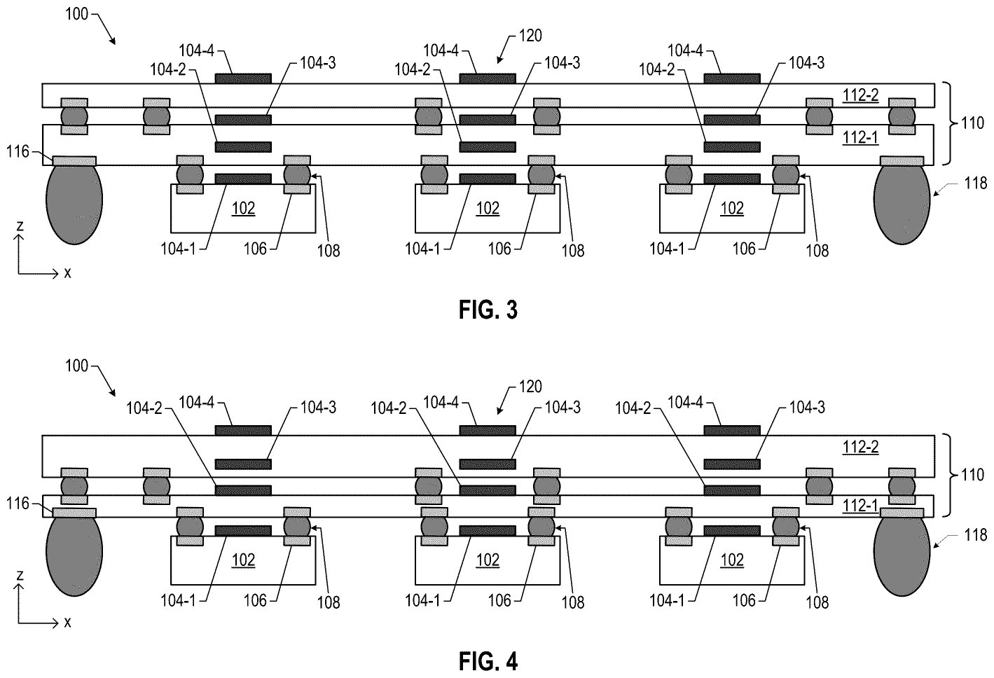

Any of the features discussed with reference to any of accompanying drawings herein may be combined with any other features to form an antenna module 100, an IC package 140, or a communication device 210/220, as appropriate. For convenience, the phrase “IC components 102” may be used to refer to the collection of IC components 102-1, 102-2, and so on, the phrase “antenna patches 104” may be used to refer to the collection of antenna patches 104-1, 104-2, and so on, etc. A number of elements of the drawings with same reference numerals may be shared with others of the drawings; for ease of discussion, a description of these elements provided with respect to one of the drawings is not repeated for the other drawings, and these elements may take the form of any of the embodiments disclosed herein (e.g., each of FIG. 1 and FIG. 2 illustrates an IC component 102, but details of the IC component 102 are only described for FIG. 1 and not repeated for FIG. 2). To not clutter the drawings, if multiple instances of certain elements are illustrated, only some of the elements may be labeled with a reference numeral (e.g., three stacks 120 of antenna patches 104 are shown in FIG. 3 but only one of the stacks 120 is labeled with a reference numeral). Also to not clutter the drawings, not all reference numerals shown in one of the drawings are shown in other similar drawings (e.g., each of FIG. 1 and FIG. 2 illustrates an IC component 102, but a first face 103-1 and a second face 103-2 of the IC component 102 are only labeled in FIG. 1 and not in FIG. 2). The drawings are not necessarily to scale. Although many of the drawings illustrate rectilinear structures with flat walls and right-angle corners, this is simply for ease of illustration and may not reflect real-life process limitations which may cause various features to not look so “ideal” when any of the structures described herein are examined using e.g., scanning electron microscopy (SEM) images or transmission electron microscope (TEM) images. In such images of real structures, possible processing defects could also be visible, e.g., not-perfectly straight edges of materials, tapered vias or other openings, inadvertent rounding of corners or variations in thicknesses of different material layers, occasional screw, edge, or combination dislocations within the crystalline region, and/or occasional dislocation defects of single atoms or clusters of atoms. There may be other defects not listed here but that are common within the field of semiconductor device fabrication and packaging. Inspection of layout and mask data and reverse engineering of parts of a device to reconstruct the circuit using e.g., optical microscopy, TEM, or SEM, and/or inspection of a cross-section of a device to detect the shape and the location of various device elements described herein using, e.g., Physical Failure Analysis (PFA) would allow determination of presence of antenna modules as described herein.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). When used to describe a range of dimensions, the phrase “between X and Y” represents a range that includes X and Y. When used to describe a location of an element, the phrase “between X and Y” represents a region that is spatially between element X and element Y. The terms “substantially,” “close,” “approximately,” “near,” and “about,” generally refer to being within +/−20%, e.g., within +/−5% or within +/−2%, of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−10%, e.g., within +/−5% or within +/−2%, of the exact orientation.

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous. As used herein, the terms “package” and “IC package” are synonymous, as are the terms “die” and “IC die.” Furthermore, the terms “chip,” “chiplet,” “die,” and “IC die” may be used interchangeably herein.

Although certain elements may be referred to in the singular herein, such elements may include multiple sub-elements. For example, “a dielectric material” may include one or more dielectric materials or “an insulator material” may include one or more insulator materials. The terms “oxide,” “carbide,” “nitride,” etc. refer to compounds containing, respectively, oxygen, carbon, nitrogen, etc. The term “high-k dielectric” refers to a material having a higher dielectric constant than silicon oxide, while the term “low-k dielectric” refers to a material having a lower dielectric constant than silicon oxide. The term “insulating” and variations thereof (e.g., “insulative” or “insulator”) means “electrically insulating,” the term “conducting” and variations thereof (e.g., “conductive” or “conductor”) means “electrically conducting,” unless otherwise specified. With reference to optical signals and/or devices, components and elements that operate on or using optical signals, the term “conducting” can also mean “optically conducting.” The term “insulating material” refers to solid materials (and/or liquid materials that solidify after processing as described herein) that are substantially electrically nonconducting. They may include, as examples and not as limitations, organic polymers and plastics, and inorganic materials such as ionic crystals, porcelain, glass, silicon and alumina or a combination thereof. They may include dielectric materials, high polarizability materials, and/or piezoelectric materials. They may be transparent or opaque without departing from the scope of the present disclosure. Further examples of insulating materials are underfills and molds or mold-like materials used in packaging applications, including for example, materials used in organic interposers, package supports and other such components.

In a general sense, an “interconnect” refers to any element that provides a physical connection between two other elements. For example, an electrical interconnect provides electrical connectivity between two electrical components, facilitating communication of electrical signals between them; an optical interconnect provides optical connectivity between two optical components, facilitating communication of optical signals between them. As used herein, both electrical interconnects and optical interconnects are comprised in the term “interconnect.” The nature of the interconnect being described is to be understood herein with reference to the signal medium associated therewith. Thus, when used with reference to an electronic device, such as an IC that operates using electrical signals, the term “interconnect” describes any element formed of an electrically conductive material for providing electrical connectivity to one or more elements associated with the IC or/and between various such elements. Likewise, when used with reference to a device that operates on optical signals as well, such as a photonic IC (PIC), “interconnect” may also describe any element formed of a material that is optically conductive for providing optical connectivity to one or more elements associated with the PCI. In such cases, the term “interconnect” may refer to optical waveguides (e.g., structures that guide and confine light waves), including optical fiber, optical splitters, optical combiners, optical couplers, and optical vias.

FIG. 1 is a side, cross-sectional view of an antenna module 100, in accordance with various embodiments. The antenna module 100 may include an IC component 102 and a stack 120 of two or more antenna patches 104 stacked above one another over the IC component 102. The antenna patches 104 of the stack 120 are shown in FIG. 1 and subsequent drawings as antenna patches 104-1, 104-2, 104-3, and 104-4, but, in various embodiments of an antenna module 100, any other number of two or more antenna patches 104 may be included in a given stack 120, and, if an antenna module 100 includes multiple stacks 120 (e.g., as shown in FIGS. 3-6) then different stacks 120 may include same or different numbers of antenna patches 104.

The antenna patches 104 may be any suitable antenna units for supporting one or more communication bands (e.g., dual band operation or tri-band operation). For example, in some embodiments, the antenna module 100 may support tri-band operation at 28 gigahertz (GHZ), 39 GHZ, and 60 GHZ. In other embodiments, the antenna module 100 may support tri-band operation at 24.5 GHz to 29 GHZ, 37 GHz to 43 GHZ, and 57 GHz to 71 GHz. Various ones of the antenna modules 100 disclosed herein may support 5G communications and 60 GHz communications. Various ones of the antenna modules 100 disclosed herein may support 28 GHz and 39 GHz communications. Various ones of the antenna modules 100 disclosed herein may support communications above 100 GHZ, e.g., 120 GHZ, 170 GHz and 220 GHz communications. Various of the antenna modules 100 disclosed herein may support millimeter wave communications. Various ones of the antenna modules 100 disclosed herein may support high band frequencies and low band frequencies. In some embodiments, different antenna patches 104 may be used for bandwidth enhancement, e.g., by being designed to resonate at slightly different frequencies. Individual antenna patches 104 may be of any shape, such as square, rectangular, circular, oval, etc., and may be a solid or mesh structure. Any conductors including, but not limited to, ink, plated metal, or liquid metal, may be used to implement individual antenna patches 104.

The IC component 102 may include a first face 103-1 and an opposing second face 103-2, and an antenna patch support 110 may be arranged over the second face 103-2 (i.e., the antenna patch support 110 may be closer to the second face 103-2 than to the first face 103-1 of the IC component 102). The antenna patches 104 of the stack 120 may be distributed between the IC component 102 and the antenna patch support 110 so that the first antenna patch 104-1 is provided on the second face 103-2 of the IC component 102 and all other antenna patches 104 of the stack 120 are stacked above the first antenna patch 104-1 and are in or on the antenna patch support 110. In some embodiments, the first antenna patch 104-1 may be a part of a metallization layer at the second face 103-2 of the IC component 102. In other embodiments, the first antenna patch 104-1 may be mechanically attached to the second face 103-2 of the IC component 102, e.g., using an adhesive such as epoxy. In some embodiments, the first antenna patch 104-1 may be a surface-mount component attached to the second face 103-2 of the IC component 102. In some embodiments, a thickness of the stack 120 may be less than 1 millimeter (e.g., between 0.4 millimeters and 0.7 millimeters).

The IC component 102 may be any IC component with electrically conductive material pathways 105 formed of an electrically conductive material (e.g., a metal such as copper) for providing signals, ground, and/or power to/from at the first antenna patch 104-1. To that end, one or more of the electrically conductive material pathways 105 may be in contact with (e.g., directly electrically connected to) an electrically conductive material of the first antenna patch 104-1. In some embodiments, the electrically conductive material pathways 105 in the IC component 102 may include conductive vias, conductive lines, and other structures extending through and, when needed, isolated from one another from by one or more dielectric materials of the IC component 102. Any suitable dielectric material may be used (e.g., laminate materials, spin-coated materials, sprayed materials, etc.). In some embodiments, the dielectric material may be an organic dielectric material, a fire-retardant grade 4 material (FR-4), bismaleimide triazine (BT) resin, polyimide materials, glass reinforced epoxy matrix materials, or low-k and ultra-low-k dielectric (e.g., carbon-doped dielectrics, fluorine-doped dielectrics, porous dielectrics, and organic polymeric dielectrics). In some embodiments, the electrically conductive material pathways 105 in the IC component 102 may include RF transmission structures (e.g., antenna feed structures, such as striplines, microstriplines, or coplanar waveguides) that may enable antenna patches 104 of one or more stacks 120 of an antenna module 100 to transmit and receive electromagnetic waves under the control of transceiver circuitry.

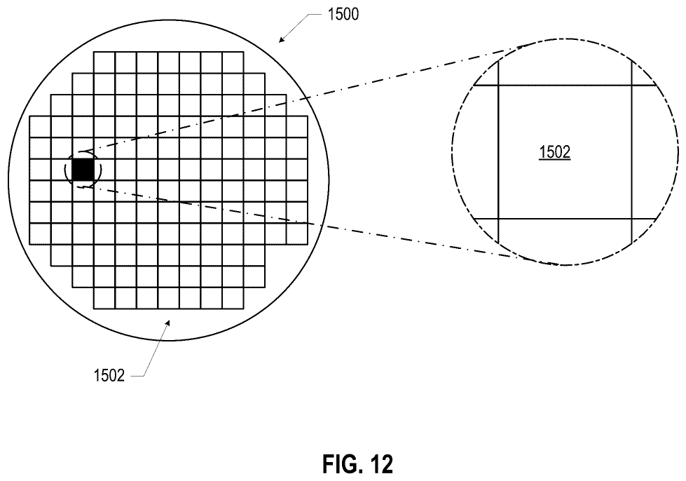

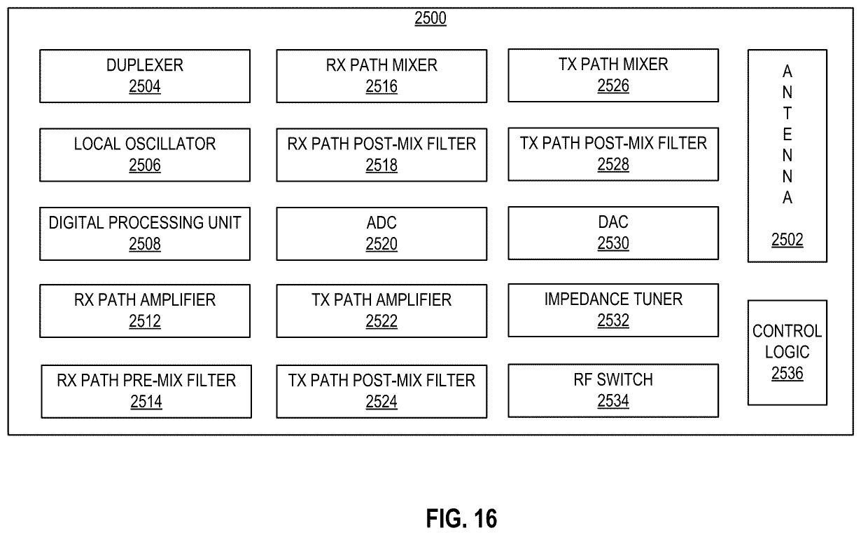

In some embodiments, the IC component 102 may include a die, e.g., an RF communication die. In such embodiments, at least portions of the transceiver circuitry may be included in the IC component 102. Transceiver circuitry may, for example, include one or more components shown in FIG. 16 besides the antenna 2502; the antenna patches 104 may be included in the antenna 2502 of FIG. 16. In such embodiments, the IC component 102 may be any suitable support structure over which transceiver circuitry in the form of one or more ICs may be provided. For example, the IC component 102 may be a substrate, a die, a wafer or a chip. For example, the IC component 102 may be the wafer 1500 of FIG. 12, discussed below, and may be, or be included in, a die, e.g., the singulated die 1502 of FIG. 12, discussed below. The IC component 102 may be, or may include, a semiconductor substrate, e.g., a semiconductor substrate 1602 described below. In some embodiments, the IC component 102 may be a printed circuit board (PCB) substrate. In some embodiments, the IC component 102 may include a resistor, capacitor (e.g., decoupling capacitors), inductor, DC-DC converter circuitry, or other circuit elements. In some embodiments, the IC component 102 may include memory device programmed with instructions to execute beam forming, scanning, and/or codebook functions.

In other embodiments, the IC component 102 may include electrically conductive material pathways 105 but no active circuitry. In some embodiments, the electrically conductive material pathways 105 in the IC component 102 may include various conductive contacts such as pads, and various interconnects such as solder balls. The electrically conductive material pathways 105 shown in FIG. 1 provide just one example of how some conductive lines and conductive vias may be arranged in the IC component 102 and be in contact with the first antenna patch 104-1; in other embodiments, the electrically conductive material pathways 105 may be arranged differently.

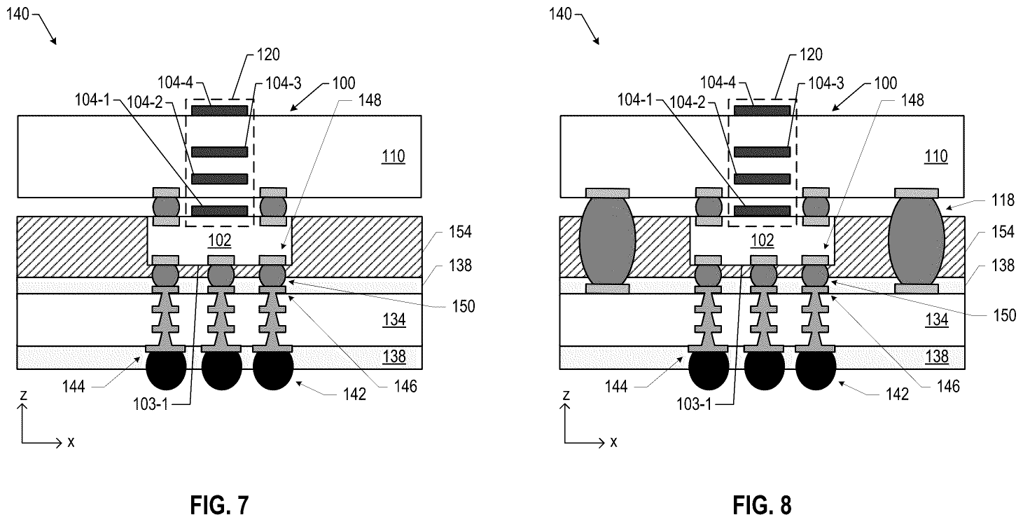

Similarly, antenna patch support 110 may include electrically conductive material pathways 115 formed of an electrically conductive material (e.g., a metal such as copper), which may include any combination of conductive lines, conductive vias, etc., extending through and, when needed, isolated from one another from by one or more dielectric materials of the antenna patch support 110. Descriptions provided with respect to the electrically conductive material pathways 105 are applicable to the electrically conductive material pathways 115 are, in the interests of brevity, are not repeated. In some embodiments, the electrically conductive material pathways 115 may include electrically conductive material pathways so that signals, ground, and/or power may be provided to the IC component 102 via the antenna patch support 110. To that end, the IC component 102 may include conductive contacts 106 at the second face 103-2 of the IC component 102, the antenna patch support 110 may include conductive contacts 116 at the face of the antenna patch support 110 closest to the IC component 102, and interconnects 108 (e.g., solder or other interconnects) between one or more conductive contacts 106 and corresponding conductive contacts 116, as shown in FIG. 1. As used herein, a “conductive contact” may refer to a portion of conductive material (e.g., metal) serving as an interface between different components; conductive contacts may be recessed in, flush with, or extending away from a surface of a component, and may take any suitable form (e.g., a conductive pad or socket or portion of a conductive line or via). In some embodiments, the conductive contacts 106/interconnects 108/conductive contacts 116 may provide an electrically conductive material pathway through which signals may be transmitted between the IC component 102 and the antenna patch support 110. In other embodiments, the conductive contacts 106/interconnects 108/conductive contacts 116 may be used only for mechanical coupling between the IC component 102 and the antenna patch support 110. The height of the interconnects 108 may control the distance between the IC component 102 and the proximate face of the antenna patch support 110. As also shown in FIG. 1, in some embodiments, interconnects 118 may be used to couple some of the conductive contacts 116 to a further component. Such further components are not specifically shown in FIG. 1, but an example of such a further component could be a package substrate 134, as shown in FIG. 8. In other embodiments, the interconnects 118 (as well as corresponding conductive contacts 116) may be absent from the antenna module 100, e.g., as shown in FIG. 7.

In some embodiments, an air gap may be present between the top surface of the first antenna patch 104-1 at the second face 103-2 of the IC component 102 and the proximate face of the antenna patch support 110, as shown in FIG. 1. In other embodiments, a solid dielectric material (not shown) may be present between the top surface of the first antenna patch 104-1 at the second face 103-2 of the IC component 102 and the proximate face of the antenna patch support 110. Such a solid dielectric material may, e.g., include a mold material and/or a solder resist, some examples of which are described below. In some embodiments, a distance between the top surface of the first antenna patch 104-1 at the second face 103-2 of the IC component 102 and the proximate face of the antenna patch support 110 may be between about 0.001 millimeters and 1.5 millimeters. In some embodiments, the total z-height of an antenna stack 120 may be less than 3 millimeters (e.g., between 2 millimeters and 3 millimeters). These values for the distance and the total z-height may be particularly suitable for frequencies of operation of about 39 GHz and below, which are at the lower end of the millimeter wave spectrum. For the higher end, e.g., for frequencies of operation of about 90 GHz and above, the distance between the top surface of the first antenna patch 104-1 at the second face 103-2 of the IC component 102 and the proximate face of the antenna patch support 110 may be between about 0.001 millimeters and 0.05 millimeters, while the total z-height of an antenna stack 120 may be less than 1 millimeter (e.g., between 0.05 millimeters and 1 millimeter).

In some embodiments, the antenna patch support 110 may include an antenna substrate 112, as shown in FIG. 1. In some embodiments, at least a portion of the antenna substrate 112 may be fabricated using PCB technology and may include between two and eight PCB layers. In various embodiments, an antenna substrate 112 may be a microelectronic package substrate. In various embodiments, an antenna substrate 112 may be a multilayer package substrate based on glass, polymer, ceramic or other semiconductor packaging materials. For example, an antenna substrate 112 may be a PCB or a multilayer package substrate that includes a core including glass, e.g., a core including a glass layer, where the glass layer may be bulk glass or a solid volume of glass, as opposed to, e.g., glass fiber reinforced polymers (i.e., in some embodiments, the glass layer does not include any glass fiber reinforced polymers). In some embodiments, an antenna substrate 112 may be semiconductor substrate; in such embodiments, the antenna substrate 112 may include any of the materials described with reference to the semiconductor substrate that may be included in the IC component 102. In some embodiments, an antenna substrate 112 may be a glass core structure. As used herein, the term “glass core” refers to a structure (e.g., a portion of a glass layer) of any glass material such as quartz, silica, fused silica, silicate glass (e.g., boro-silicate glass or alumo-silicate glass), soda-lime glass, soda-lime silica, borofloat glass, lead borate glass, photosensitive glass, non-photosensitive glass, or ceramic glass. In context of the present disclosure, the glass core refers to bulk glass or a solid volume of glass, as opposed to, e.g., materials that may include particles of glass, such as glass fiber reinforced polymers. Such glass materials are typically non-crystalline, often transparent, amorphous solids. However, in some embodiments, what is described herein as a glass core may include solid materials other than glass, e.g., mica, as long as those materials have sufficiently low dielectric constants, e.g., lower than that of silicon (i.e., lower than about 11). In some embodiments, a glass core may include a material, e.g., any of the materials described above, with a weight percentage of silicon being at least about 0.5%, e.g., between about 0.5% and 50%, or between about 1% and 48%. For example, if a glass core is fused silica, the weight percentage of silicon may be about 47%.

All of the antenna patches 104 of the stack 120 besides the first antenna patch 104-1 may be embedded in one or more solid material of the antenna patch support 110 and/or provided at one or more faces of the antenna patch support 110. For example, in the illustration of FIG. 1, the antenna patches 104-2 and 104-3 are embedded in one or more solid material of the antenna substrate 112, while the antenna patch 104-4 is provided at the face of the antenna substrate 112 that is opposite to the face of the antenna substrate 112 proximate to the IC component 102.

While FIG. 1 illustrates an embodiment where the antenna patch support 110 includes a single antenna substrate 112, in other embodiments, the antenna patch support 110 may include two or more antenna substrates 112 stacked above one another. In such embodiments, the antenna patches 104 of the stack 120 besides the first antenna patch 104-1 may be embedded in solid materials of one or more antenna substrates 112 of multiple antenna substrates 112 of the antenna patch support 110 and/or provided at one or more faces of one or more antenna substrates 112 of the antenna patch support 110. In some embodiments, using two or more antenna substrates 112 may advantageously allow using different materials as solid dielectric materials in or on which the antenna patches 104 may be implemented. For example, one of the antenna substrates 112 may include a glass core in/on which antenna patches 104 may be implemented, while another one of the antenna substrates 112 may be a copper cladded laminate (CCL) substrate. In some embodiments, using two or more antenna substrates 112 may advantageously allow using antenna substrates 112 that may be separately fabricated (e.g., fabricated by different manufacturers or fabricated by the same manufacturer but in parallel) and assembled, enabling increased degrees of design freedom and improved yield.

FIG. 2 provides one example of the antenna patch support 110 including multiple antenna substrates 112, shown as a first antenna substrate 112-1 and a second antenna substrate 112-2. In such embodiments, some of the antenna patches 104 of the stack 120 may be implemented on faces of one or more of the multiple antenna substrates 112 (e.g., in FIG. 2, the antenna patch 104-3 is illustrated to be on a face of the first antenna substrate 112-1 and the antenna patch 104-4 is illustrated to be on a face of the second antenna substrate 112-2) and/or some of the antenna patches 104 of the stack 120 may be embedded in one or more of the multiple antenna substrates 112 (e.g., in FIG. 2, the antenna patch 104-2 is illustrated to be embedded in the solid dielectric material of the first antenna substrate 112-1). In some embodiments, conductive contacts 122 may be present at a face of the first antenna substrate 112-1 that faces the second antenna substrate 112-2, conductive contacts 124 may be present at a face of the second antenna substrate 112-2 that faces the first antenna substrate 112-1, and interconnects 126 (e.g., solder) may be present between the conductive contacts 122 and 124, to provide electrical coupling between electrically conductive material pathways of the first and second antenna substrates 112. In various embodiments of an antenna module 100, any other number of two or more antenna substrates 112 may be included in an antenna patch support 110, and the antenna patches 104-2, and so on may be distributed in a different manner in or on any of the two or more antenna substrates 112 than what is shown in FIG. 2 and some of the subsequent drawings.

Any of the antenna patches 104 provided on a face of one of the antenna substrates 112 of the antenna module 100 may be implemented as described with reference to the first patch 104-1. For example, such antenna patches 104 may be provided as a part of a metallization layer of any of the antenna substrates 112, mechanically coupled to the face of any of the antenna substrates 112 or be provided as surface-mount components. In some embodiments all of the antenna patches 104 provided in or on the one or more antenna substrates 112 of the antenna patch support 110 may be electrically isolated from all electrically conductive material pathways in the antenna patch support 110. In particular, the antenna patches 104 of a stack 120 may be arranged in such a way so that no electrically conductive materials (e.g., electrically conductive materials of the conductive lines, conductive vias, conductive contacts, or interconnects such as solder) are present between adjacent nearest antenna patches 104. In some embodiments, the antenna patches 104 of a stack 120 may be arranged in such a way so that no electrically conductive materials are present within the footprints of any of the antenna patches 104 between any pair of nearest-neighbor antenna patches 104 of a given stack 120, which may reduce or eliminate losses due to signal reflection due to the mismatch at the transition between the antenna patch support 110 and the IC component 102, which may, advantageously, lead to lower requirements for impedance matching networks for the antenna module 100. Placing the first antenna patch 104-1 (i.e., the lowest antenna patch 104) of a stack 120 on the face of an IC component 102 and providing other antenna patches 104 as a multilayer structure above the IC component 102 may allow bypassing traditional losses affecting conventional IC packages that attempt to integrate antenna units together with IC components.

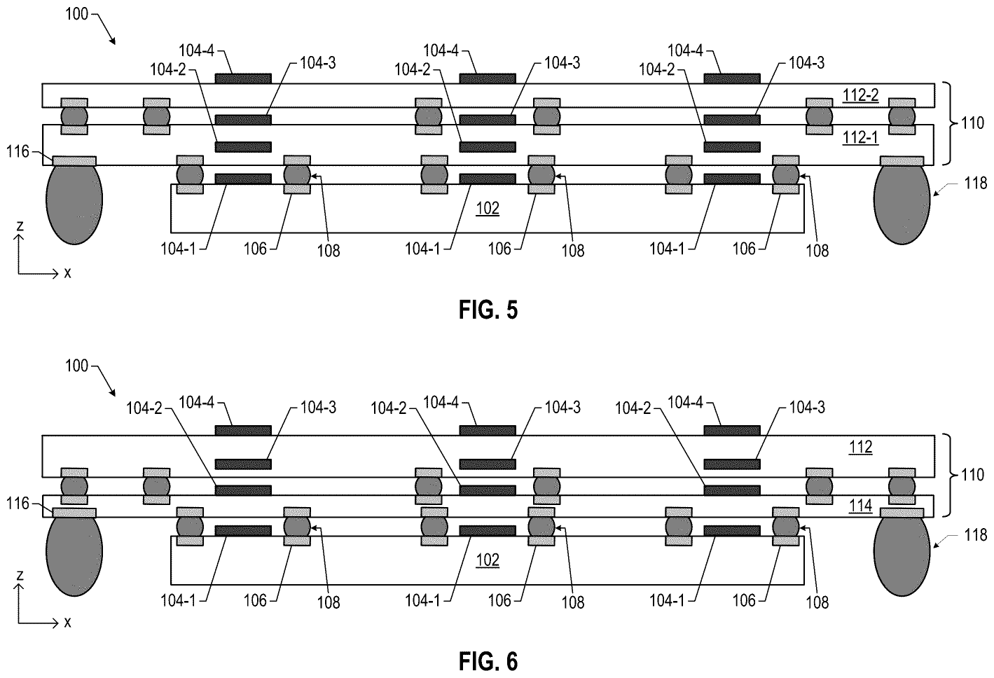

While FIGS. 1-2 illustrate antenna modules 100 with a single stack 120 of antenna patches 104, in other embodiments, antenna modules 100 may include multiple such stacks 120, where some or all of the stacks 120 may be implemented as described with reference to FIGS. 1-2. For example, FIG. 3 illustrates an antenna module 100 similar to that shown in FIG. 2 but having three stacks 120 of two or more antenna patches 104, while FIG. 4 illustrates an antenna module similar to that shown in FIG. 3, but with different distribution of the antenna patches 104 in the two antenna substrates 112. In particular, FIG. 4 illustrates an embodiment where, similar to FIG. 3, the antenna patch 104-4 is on a face of the second antenna substrate 112-2, but, different from FIG. 3, the antenna patch 104-2 is on a face of the first antenna substrate 112-1 and the antenna patch 104-3 is embedded in the solid dielectric material of the second antenna substrate 112-2. One cross-sectional side view is shown in FIGS. 3-4, but such arrangement of multiple stacks 120 may be a two-dimensional arrangement where, in various embodiments, individual stacks 120 may operate individually or together as a linear, circular, or rectangular phased array antenna. This is applicable to both embodiments where they have individual IC components 102 as shown in FIGS. 3-4, or if two or more of the antenna stacks 120 are controlled by a shared IC component 102 as shown in FIGS. 5-6.

In some embodiments, an antenna module 100 may include a different IC component 102 for controlling each different stack 120 of antenna units 104, e.g., as shown in FIGS. 3-4. In other embodiments, an antenna module 100 may include one IC component 102 for controlling multiple stacks 120 of antenna units 104, e.g., as shown in FIGS. 5-6. In particular, FIG. 5 illustrates an antenna module 100 similar to that shown in FIG. 3, but having three stacks 120 implemented over a single IC component 102, while FIG. 6 illustrates an antenna module similar to that shown in FIG. 4, but, similar to FIG. 5, having three stacks 120 implemented over a single IC component 102.

The antenna module 100 may be included in any suitable IC package. For example, FIG. 7 illustrates an example IC package 140 that may include an antenna module 100 comprising an IC component 102, a stack 120 of antenna patches 104, and an antenna patch support 110 as described above, where the IC package 140 further includes a package substrate 134. As used herein, the term “package substrate” may be used to describe any substrate material that facilitates the packaging together of any collection of semiconductor dies and/or other electrical components such as passive electrical components. As used herein, a package substrate may be formed of any material including, but not limited to, insulating materials such as resin impregnated glass fibers (e.g., PCB or Printed Wiring Boards (PWB)), glass, ceramic, silicon, silicon carbide, etc. In addition, as used herein, a package substrate may refer to a substrate that includes buildup layers (e.g., Ajinomoto Buildup Film (ABF) layers). In some embodiments, a package substrate may be a PCB or a multilayer package substrate that includes a core including glass, e.g., a core including a glass layer, where the glass layer may be bulk glass or a solid volume of glass, as opposed to, e.g., glass fiber reinforced polymers (i.e., in some embodiments, the glass layer does not include any glass fiber reinforced polymers). In some embodiments, the IC package 140 may be a system-in-package (SiP). In some embodiments, the IC package 140 may be a flip chip (FC) chip scale package (CSP).

As shown in FIG. 7, an IC component 102 (or a plurality of such IC components 102) may be coupled to the package substrate 134 by first-level interconnects 150. In particular, conductive contacts 146 at one face of the package substrate 134 may be coupled to conductive contacts 148 at the first face 103-1 of the IC component 102 by first-level interconnects 150. The first-level interconnects 150 illustrated in FIG. 7 are solder bumps, but any suitable first-level interconnects 150 may be used.

A solder resist 138 may be disposed around the conductive contacts 146. The package substrate 134 may include a dielectric material, and may have conductive pathways (e.g., including conductive vias and lines) extending through the dielectric material between the faces, or between different locations on each face. In some embodiments, the package substrate 134 may have a thickness less than 1 millimeter (e.g., between 0.1 millimeters and 0.5 millimeters). Conductive contacts 144 may be disposed at the other face of the package substrate 134, and second-level interconnects 142 may couple these conductive contacts 144 to a further component, e.g., a circuit board (not shown). The second-level interconnects 142 illustrated in FIG. 7 are solder balls (e.g., for a ball grid array arrangement), but any suitable second-level interconnects 142 may be used (e.g., pins in a pin grid array arrangement or lands in a land grid array arrangement). A solder resist 138 may be disposed around the conductive contacts 144. In some embodiments, a mold material 154 may be disposed around the IC components 102 (e.g., between the IC components 102 and the package substrate 134 as an underfill material). In some embodiments, a thickness of the mold material may be less than 1 millimeter. Example materials that may be used for the mold material 154 include epoxy mold materials, as suitable.

Although not specifically shown in the present drawings, in some embodiments, a package substrate 134 of an IC package 140 with an antenna module 100 may include one or more recesses. In such embodiments, a bottom surface of a recess in the package substrate 134 may be provided by solid material of the package substrate 134. A recess may be formed in a package substrate 134 in any suitable manner (e.g., via three-dimensional printing, laser cutting or drilling the recess into an existing package substrate, etc.). One or more antenna modules may be positioned over or at least partially in such a recess.

FIG. 8 illustrates yet another example IC package 140 that may include an antenna module 100. In particular, FIG. 8 illustrates an IC package 140 similar to that shown in FIG. 7, but further illustrating that the antenna patch support 110 may be directly coupled to the package substrate 134 using interconnects 118 as described above.

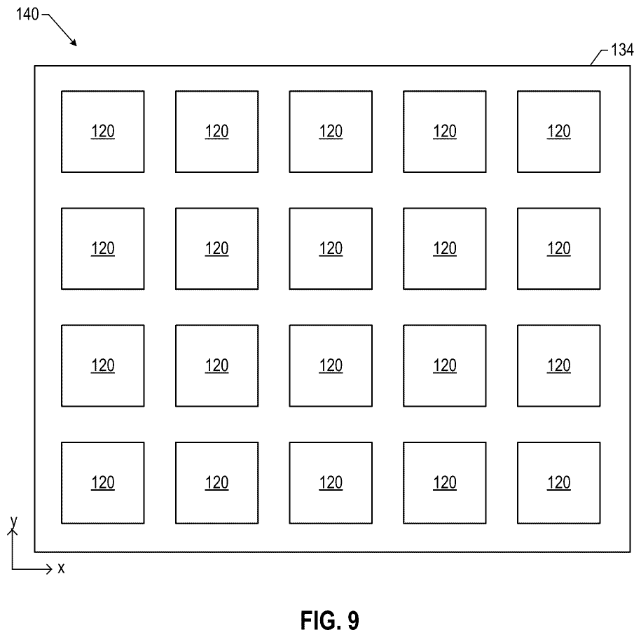

In some embodiments, an IC package 140 may include multiple stacks 120 provided over a single package substrate 134, as illustrated in FIG. 9, showing a top-down view of another example IC package 140. The multiple stacks 120 may included in one or more antenna modules 100 as described herein. FIG. 9 illustrates that, in some embodiments, a plurality of stacks 120 of the one or more antenna modules 100 may be distributed regularly over one face of the package substrate 134; in other embodiments, stacks 120 of the one or more antenna modules 100 may have other arrangements of the stacks 120 with respect to a package substrate 134.

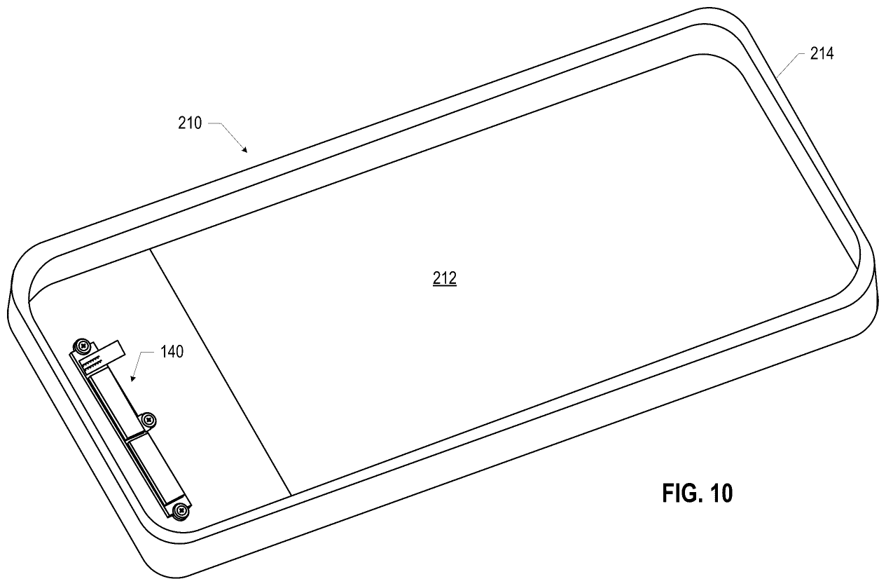

Antenna modules 100 and/or antenna packages 140 disclosed herein may be included in any suitable communication device (e.g., a computing device with wireless communication capability, a wearable device with wireless communication circuitry, etc.). For example, FIG. 10 is a perspective view of a handheld communication device 210 including an IC package 140 with one or more antenna modules 100, in accordance with various embodiments. In particular, FIG. 10 depicts that the IC package 140 (and associated IC package fixtures) may be coupled to a chassis 212 of the handheld communication device 210. A metal or plastic housing 214 may provide the “sides” of the communication device 210. In some embodiments, the handheld communication device 210 may be a smart phone.

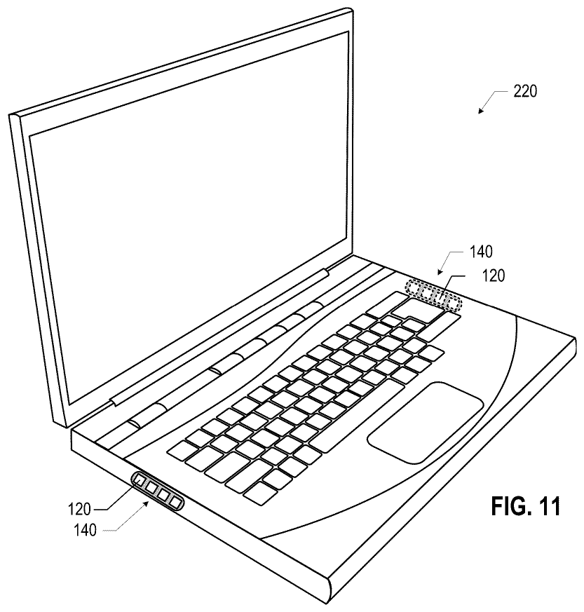

FIG. 11 is a perspective view of a laptop communication device 220 including multiple IC packages 140, each including one or more antenna modules 100, in accordance with various embodiments. In particular, FIG. 11 depicts an IC package 140 coupled to one or more antenna modules 100 with four stacks 120 of antenna patches 104 at either side of the keyboard of a laptop communication device 220. The stacks 120 may occupy an area on the outside housing of the laptop communication device 220 that is approximately equal to or less than the area required for two adjacent Universal Serial Bus (USB) connectors (i.e., approximately 5 millimeters (height) by 22 millimeters (width) by 2.2 millimeters (depth).

The antenna modules 100 disclosed herein may include, or be included in, any suitable electronic component. FIGS. 12-16 illustrate various examples of apparatuses that may include, or be included in, any of the antenna modules 100 disclosed herein.

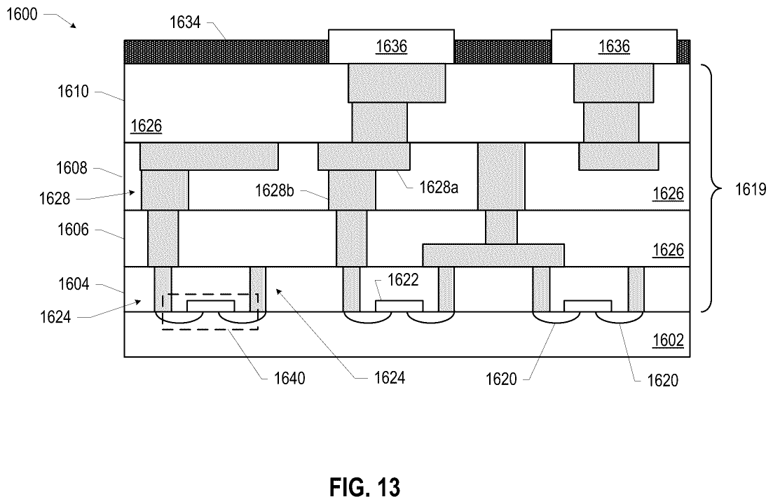

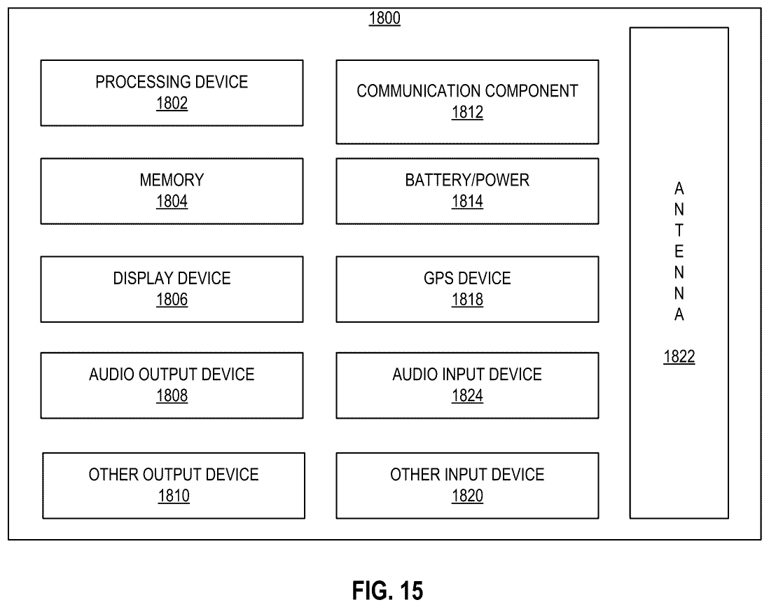

FIG. 12 is a top view of a wafer 1500 and dies 1502 that may be included in any of the antenna modules 100 disclosed herein. For example, a die 1502 may be any of the IC components 102 described herein. The wafer 1500 may be composed of semiconductor material and may include one or more dies 1502 having IC structures formed on a surface of the wafer 1500. Each of the dies 1502 may be a repeating unit of a semiconductor product that includes any suitable IC. After the fabrication of the semiconductor product is complete, the wafer 1500 may undergo a singulation process in which the dies 1502 are separated from one another to provide discrete “chips” of the semiconductor product. The die 1502 may include one or more transistors (e.g., some of the transistors 1640 of FIG. 13, discussed below) and/or supporting circuitry to route electrical signals to the transistors, as well as any other IC components. In some embodiments, the wafer 1500 or the die 1502 may include a memory device (e.g., a random-access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 1502. For example, a memory array formed by multiple memory devices may be formed on a same die 1502 as a processing device (e.g., the processing device 1802 of FIG. 15) or other logic that is configured to store information in the memory devices or execute instructions stored in the memory array.

FIG. 13 is a side, cross-sectional view of an IC device 1600 that may be included in any of the antenna modules 100 disclosed herein. For example, an IC device 1600 may be included in an IC component 102. The IC device 1600 may be formed on a substrate 1602 (e.g., the wafer 1500 of FIG. 12) and may be included in a die (e.g., the die 1502 of FIG. 12). The substrate 1602 may be a semiconductor substrate composed of semiconductor material systems including, for example, n-type or p-type materials systems (or a combination of both). The substrate 1602 may include, for example, a crystalline substrate formed using a bulk silicon or a silicon-on-insulator (SOI) substructure. In some embodiments, the substrate 1602 may be formed using alternative materials, which may or may not be combined with silicon, that include but are not limited to germanium, indium antimonide, lead telluride, indium arsenide, indium phosphide, gallium arsenide, or gallium antimonide. Further materials classified as group III-V materials (i.e., materials from groups III and V of the periodic system of elements), group II-VI (i.e., materials from groups II and IV of the periodic system of elements), or group IV materials (i.e., materials from group IV of the periodic system of elements) may also be used to form the substrate 1602. Although a few examples of materials from which the substrate 1602 may be formed are described here, any material that may serve as a foundation for an IC device 1600 may be used. The substrate 1602 may be part of a singulated die (e.g., the dies 1502 of FIG. 12) or a wafer (e.g., the wafer 1500 of FIG. 12).

The IC device 1600 may include one or more device layers 1604 disposed on the substrate 1602. The device layer 1604 may include features of one or more transistors 1640 (e.g., metal oxide semiconductor field-effect transistors (MOSFETs)) formed on the substrate 1602. The device layer 1604 may include, for example, one or more source and/or drain (S/D) regions 1620, a gate 1622 to control current flow in the transistors 1640 between the S/D regions 1620, and one or more S/D contacts 1624 to route electrical signals to/from the S/D regions 1620. The transistors 1640 may include additional features not depicted for the sake of clarity, such as device isolation regions, gate contacts, and the like. The transistors 1640 are not limited to the type and configuration depicted in FIG. 13 and may include a wide variety of other types and configurations such as, for example, planar transistors, non-planar transistors, or a combination of both. Planar transistors may include bipolar junction transistors (BJT), heterojunction bipolar transistors (HBT), or high-electron-mobility transistors (HEMT). Non-planar transistors may include FinFET transistors, such as double-gate transistors or tri-gate transistors, and wrap-around or all-around gate transistors, such as nanoribbon and nanowire transistors.

Each transistor 1640 may include a gate 1622 formed of at least two layers, a gate dielectric and a gate electrode. The gate dielectric may include one layer or a stack of layers. The one or more layers may include silicon oxide, silicon dioxide, silicon carbide, and/or a high-k dielectric material. The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 1640 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer. For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 1640 along the source-channel-drain direction, the gate electrode may consist of a U-shaped structure that includes a bottom portion substantially parallel to the surface of the substrate and two sidewall portions that are substantially perpendicular to the top surface of the substrate. In other embodiments, at least one of the metal layers that form the gate electrode may simply be a planar layer that is substantially parallel to the top surface of the substrate and does not include sidewall portions substantially perpendicular to the top surface of the substrate. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 1620 may be formed within the substrate 1602 adjacent to the gate 1622 of each transistor 1640. The S/D regions 1620 may be formed using an implantation/diffusion process or an etching/deposition process, for example. In the former process, dopants such as boron, aluminum, antimony, phosphorous, or arsenic may be ion-implanted into the substrate 1602 to form the S/D regions 1620. An annealing process that activates the dopants and causes them to diffuse farther into the substrate 1602 may follow the ion-implantation process. In the latter process, the substrate 1602 may first be etched to form recesses at the locations of the S/D regions 1620. An epitaxial deposition process may then be carried out to fill the recesses with material that is used to fabricate the S/D regions 1620. In some implementations, the S/D regions 1620 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 1620 may be formed using one or more alternate semiconductor materials such as germanium or a group III-V material or alloy. In further embodiments, one or more layers of metal and/or metal alloys may be used to form the S/D regions 1620.

Electrical signals, such as power and/or input/output (I/O) signals, may be routed to and/or from the devices (e.g., the transistors 1640) of the device layer 1604 through one or more interconnect layers disposed on the device layer 1604 (illustrated in FIG. 13 as interconnect layers 1606-1610). For example, electrically conductive features of the device layer 1604 (e.g., the gate 1622 and the S/D contacts 1624) may be electrically coupled with the interconnect structures 1628 of the interconnect layers 1606-1610. The one or more interconnect layers 1606-1610 may form a metallization stack (also referred to as an “ILD stack”) 1619 of the IC device 1600.

The interconnect structures 1628 may be arranged within the interconnect layers 1606-1610 to route electrical signals according to a wide variety of designs (in particular, the arrangement is not limited to the particular configuration of interconnect structures 1628 depicted in FIG. 13). Although a particular number of interconnect layers 1606-1610 is depicted in FIG. 13, embodiments of the present disclosure include IC devices having more or fewer interconnect layers than depicted.

In some embodiments, the interconnect structures 1628 may include lines 1628a and/or vias 1628b filled with an electrically conductive material such as a metal. The lines 1628a may be arranged to route electrical signals in a direction of a plane that is substantially parallel with a surface of the substrate 1602 upon which the device layer 1604 is formed. For example, the lines 1628a may route electrical signals in a direction in and out of the page from the perspective of FIG. 13. The vias 1628b may be arranged to route electrical signals in a direction of a plane that is substantially perpendicular to the surface of the substrate 1602 upon which the device layer 1604 is formed. In some embodiments, the vias 1628b may electrically couple lines 1628a of different interconnect layers 1606-1610 together.

The interconnect layers 1606-1610 may include a dielectric material 1626 disposed between the interconnect structures 1628, as shown in FIG. 13. In some embodiments, the dielectric material 1626 disposed between the interconnect structures 1628 in different ones of the interconnect layers 1606-1610 may have different compositions; in other embodiments, the composition of the dielectric material 1626 between different interconnect layers 1606-1610 may be the same.

A first interconnect layer 1606 may be formed above the device layer 1604. In some embodiments, the first interconnect layer 1606 may include lines 1628a and/or vias 1628b, as shown. The lines 1628a of the first interconnect layer 1606 may be coupled with contacts (e.g., the S/D contacts 1624) of the device layer 1604.

A second interconnect layer 1608 may be formed above the first interconnect layer 1606. In some embodiments, the second interconnect layer 1608 may include vias 1628b to couple the lines 1628a of the second interconnect layer 1608 with the lines 1628a of the first interconnect layer 1606. Although the lines 1628a and the vias 1628b are structurally delineated with a line within each interconnect layer (e.g., within the second interconnect layer 1608) for the sake of clarity, the lines 1628a and the vias 1628b may be structurally and/or materially contiguous (e.g., simultaneously filled during a dual-damascene process) in some embodiments.

A third interconnect layer 1610 (and additional interconnect layers, as desired) may be formed in succession on the second interconnect layer 1608 according to similar techniques and configurations described in connection with the second interconnect layer 1608 or the first interconnect layer 1606. In some embodiments, the interconnect layers that are “higher up” in the metallization stack 1619 in the IC device 1600 (i.e., farther away from the device layer 1604) may be thicker.

The IC device 1600 may include a solder resist material 1634 (e.g., polyimide or similar material) and one or more conductive contacts 1636 formed on the interconnect layers 1606-1610. In FIG. 13, the conductive contacts 1636 are illustrated as taking the form of bond pads. The conductive contacts 1636 may be electrically coupled with the interconnect structures 1628 and configured to route the electrical signals of the transistor(s) 1640 to other external devices. For example, solder bonds may be formed on the one or more conductive contacts 1636 to mechanically and/or electrically couple a chip including the IC device 1600 with another component (e.g., a circuit board). The IC device 1600 may include additional or alternate structures to route the electrical signals from the interconnect layers 1606-1610; for example, the conductive contacts 1636 may include other analogous features (e.g., posts) that route the electrical signals to external components.

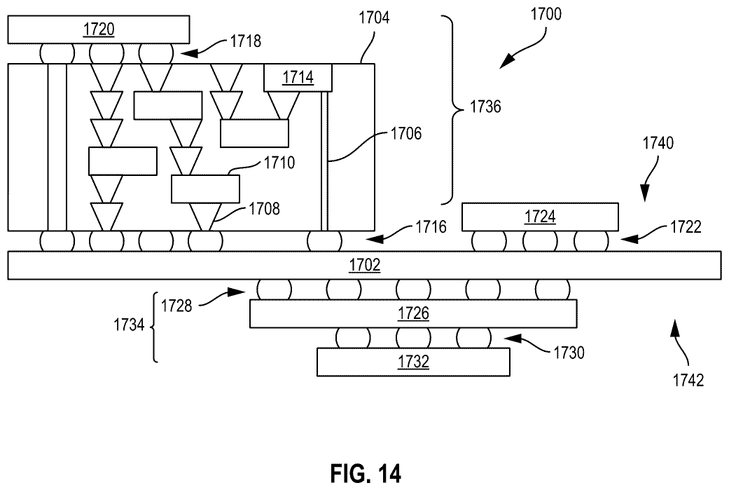

FIG. 14 is a side, cross-sectional view of an IC device assembly 1700 that may include one or more of the antenna modules 100 disclosed herein. In particular, any suitable ones of the antenna modules 100 disclosed herein may take the place of any of the components of the IC device assembly 1700 (e.g., an IC package 140 with one or more antenna modules 100 may take the place of any of the IC packages of the IC device assembly 1700).

The IC device assembly 1700 includes a number of components disposed on a circuit board 1702 (which may be, e.g., a motherboard). The IC device assembly 1700 includes components disposed on a first face 1740 of the circuit board 1702 and an opposing second face 1742 of the circuit board 1702; generally, components may be disposed on one or both faces 1740 and 1742.

In some embodiments, the circuit board 1702 may be a PCB including multiple metal layers separated from one another by layers of dielectric material and interconnected by electrically conductive vias. Any one or more of the metal layers may be formed in a desired circuit pattern to route electrical signals (optionally in conjunction with other metal layers) between the components coupled to the circuit board 1702. In other embodiments, the circuit board 1702 may be a non-PCB substrate.

The IC device assembly 1700 illustrated in FIG. 14 includes a package-on-interposer structure 1736 coupled to the first face 1740 of the circuit board 1702 by coupling components 1716. The coupling components 1716 may electrically and mechanically couple the package-on-interposer structure 1736 to the circuit board 1702, and may include solder balls (as shown in FIG. 14), male and female portions of a socket, an adhesive, an underfill material, and/or any other suitable electrical and/or mechanical coupling structure.

The package-on-interposer structure 1736 may include an IC package 1720 coupled to an interposer 1704 by coupling components 1718. The coupling components 1718 may take any suitable form for the application, such as the forms discussed above with reference to the coupling components 1716. Although a single IC package 1720 is shown in FIG. 14, multiple IC packages may be coupled to the interposer 1704; indeed, additional interposers may be coupled to the interposer 1704. The interposer 1704 may provide an intervening substrate used to bridge the circuit board 1702 and the IC package 1720. The IC package 1720 may be or include, for example, a die (the die 1502 of FIG. 12), an IC device (e.g., the IC device 1600 of FIG. 13), or any other suitable component. Generally, the interposer 1704 may spread a connection to a wider pitch or reroute a connection to a different connection. For example, the interposer 1704 may couple the IC package 1720 (e.g., a die) to a set of ball grid array (BGA) conductive contacts of the coupling components 1716 for coupling to the circuit board 1702. In the embodiment illustrated in FIG. 14, the IC package 1720 and the circuit board 1702 are attached to opposing sides of the interposer 1704; in other embodiments, the IC package 1720 and the circuit board 1702 may be attached to a same side of the interposer 1704. In some embodiments, three or more components may be interconnected by way of the interposer 1704.

In some embodiments, the interposer 1704 may be formed as a PCB, including multiple metal layers separated from one another by layers of dielectric material and interconnected by electrically conductive vias. In some embodiments, the interposer 1704 may be formed of an epoxy resin, a fiberglass-reinforced epoxy resin, an epoxy resin with inorganic fillers, a ceramic material, or a polymer material such as polyimide. In some embodiments, the interposer 1704 may be formed of alternate rigid or flexible materials that may include the same materials described above for use in a semiconductor substrate, such as silicon, germanium, and other group III-V and group IV materials. The interposer 1704 may include metal interconnects 1708 and vias 1710, including but not limited to through-silicon vias (TSVs) 1706. The interposer 1704 may further include embedded devices 1714, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as RF devices, PAs, power management devices, antennas, arrays, sensors, and microelectromechanical systems (MEMS) devices may also be formed on the interposer 1704. The package-on-interposer structure 1736 may take the form of any of the package-on-interposer structures known in the art.

The IC device assembly 1700 may include an IC package 1724 coupled to the first face 1740 of the circuit board 1702 by coupling components 1722. The coupling components 1722 may take the form of any of the embodiments discussed above with reference to the coupling components 1716, and the IC package 1724 may take the form of any of the embodiments discussed above with reference to the IC package 1720.

The IC device assembly 1700 illustrated in FIG. 14 includes a package-on-package structure 1734 coupled to the second face 1742 of the circuit board 1702 by coupling components 1728. The package-on-package structure 1734 may include an IC package 1726 and an IC package 1732 coupled together by coupling components 1730 such that the IC package 1726 is disposed between the circuit board 1702 and the IC package 1732. The coupling components 1728 and 1730 may take the form of any of the embodiments of the coupling components 1716 discussed above, and the IC packages 1726 and 1732 may take the form of any of the embodiments of the IC package 1720 discussed above. The package-on-package structure 1734 may be configured in accordance with any of the package-on-package structures known in the art.

FIG. 15 is a block diagram of an example communication device 1800 that may include one or more antenna modules 100 in accordance with any of the embodiments disclosed herein. The handheld communication device 210 (FIG. 10), and the laptop communication device 220 (FIG. 11) may be examples of the communication device 1800. Any suitable ones of the components of the communication device 1800 may include one or more of the IC packages 1650, IC devices 1600, or dies 1502 disclosed herein. A number of components are illustrated in FIG. 15 as included in the communication device 1800, but any one or more of these components may be omitted or duplicated, as suitable for the application. In some embodiments, some or all of the components included in the communication device 1800 may be attached to one or more motherboards. In some embodiments, some or all of these components are fabricated onto a single system-on-a-chip (SoC) die.

Additionally, in various embodiments, the communication device 1800 may not include one or more of the components illustrated in FIG. 15, but the communication device 1800 may include interface circuitry for coupling to the one or more components. For example, the communication device 1800 may not include a display device 1806, but may include display device interface circuitry (e.g., a connector and driver circuitry) to which a display device 1806 may be coupled. In another set of examples, the communication device 1800 may not include an audio input device 1824 or an audio output device 1808, but may include audio input or output device interface circuitry (e.g., connectors and supporting circuitry) to which an audio input device 1824 or audio output device 1808 may be coupled.

The communication device 1800 may include a processing device 1802 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 1802 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, or any other suitable processing devices. The communication device 1800 may include a memory 1804, which may itself include one or more memory devices such as volatile memory (e.g., dynamic RAM (DRAM)), nonvolatile memory (e.g., read-only memory (ROM)), flash memory, solid state memory, and/or a hard drive. In some embodiments, the memory 1804 may include memory that shares a die with the processing device 1802. This memory may be used as cache memory and may include embedded DRAM (eDRAM) or spin transfer torque magnetic RAM (STT-MRAM).

In some embodiments, the communication device 1800 may include a communication module 1812 (e.g., one or more communication modules). For example, the communication module 1812 may be configured for managing wireless communications for the transfer of data to and from the communication device 1800. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication module 1812 may be, or may include, any of the antenna modules 100 disclosed herein.

The communication module 1812 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication module 1812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication module 1812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication module 1812 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication module 1812 may operate in accordance with other wireless protocols in other embodiments. The communication device 1800 may include an antenna 1822 to facilitate wireless communications and/or to receive other wireless communications (such as AM or FM radio transmissions).

In some embodiments, the communication module 1812 may manage wired communications, such as electrical, optical, or any other suitable communication protocols (e.g., the Ethernet). As noted above, the communication module 1812 may include multiple communication modules. For instance, a first communication module 1812 may be dedicated to shorter-range wireless communications such as Wi-Fi or Bluetooth, and a second communication module 1812 may be dedicated to longer-range wireless communications such as global positioning system (GPS), EDGE, GPRS, CDMA, WiMAX, LTE, EV-DO, or others. In some embodiments, a first communication module 1812 may be dedicated to wireless communications, and a second communication module 1812 may be dedicated to wired communications. In some embodiments, the communication module 1812 may include a antenna module 100 that supports millimeter wave communication.

The communication device 1800 may include battery/power circuitry 1814. The battery/power circuitry 1814 may include one or more energy storage devices (e.g., batteries or capacitors) and/or circuitry for coupling components of the communication device 1800 to an energy source separate from the communication device 1800 (e.g., AC line power).

The communication device 1800 may include a display device 1806 (or corresponding interface circuitry, as discussed above). The display device 1806 may include any visual indicators, such as a heads-up display, a computer monitor, a projector, a touchscreen display, a liquid crystal display (LCD), a light-emitting diode display, or a flat panel display.

The communication device 1800 may include an audio output device 1808 (or corresponding interface circuitry, as discussed above). The audio output device 1808 may include any device that generates an audible indicator, such as speakers, headsets, or earbuds.

The communication device 1800 may include an audio input device 1824 (or corresponding interface circuitry, as discussed above). The audio input device 1824 may include any device that generates a signal representative of a sound, such as microphones, microphone arrays, or digital instruments (e.g., instruments having a musical instrument digital interface (MIDI) output).

The communication device 1800 may include a GPS device 1818 (or corresponding interface circuitry, as discussed above). The GPS device 1818 may be in communication with a satellite-based system and may receive a location of the communication device 1800, as known in the art.

The communication device 1800 may include an other output device 1810 (or corresponding interface circuitry, as discussed above). Examples of the other output device 1810 may include an audio codec, a video codec, a printer, a wired or wireless transmitter for providing information to other devices, or an additional storage device.

The communication device 1800 may include an other input device 1820 (or corresponding interface circuitry, as discussed above). Examples of the other input device 1820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The communication device 1800 may have any desired form factor, such as a handheld or mobile communication device (e.g., a cell phone, a smart phone, a mobile internet device, a music player, a tablet computer, a laptop computer, a netbook computer, an ultrabook computer, a personal digital assistant (PDA), an ultra mobile personal computer, etc.), a desktop communication device, a server or other networked computing component, a printer, a scanner, a monitor, a set-top box, an entertainment control unit, a vehicle control unit, a digital camera, a digital video recorder, or a wearable communication device. In some embodiments, the communication device 1800 may be any other electronic device that processes data.

FIG. 16 is a block diagram of an example RF device 2500 that may include one or more antenna modules 100 in accordance with any of the embodiments disclosed herein. For example, any suitable ones of the components of the RF device 2500 may include, or may be included in an electronic assembly 130 or an IC package 140 in accordance with any of the embodiments disclosed herein. Any of the components of the RF device 2500 may include, or be included in, an IC assembly 1700 as described with reference to FIG. 14. In some embodiments, the RF device 2500 may be included within any components of the computing device 1800 as described above with reference to FIG. 15 (e.g., the communication component 1812), or may be coupled to any of the components of the electrical device 1800 (e.g., may be coupled to the memory 1804 and/or to the processing device 1802 of the electrical device 1800). In still other embodiments, the RF device 2500 may further include any of the components described above with reference to FIG. 15, such as, but not limited to, the battery/power circuitry 1814, the memory 1804, and various input and output devices as discussed above with reference to FIG. 15.

In general, the RF device 2500 may be any device or system that may support wireless transmission and/or reception of signals in the form of electromagnetic waves in the RF range of approximately 3 kiloHertz (kHz) to 300 GHz and beyond. In some embodiments, the RF device 2500 may be used for wireless communications, e.g., in a base station (BS) or a user equipment (UE) device of any suitable cellular wireless communications technology, such as GSM, WCDMA, or LTE. In a further example, the RF device 2500 may be used as, or in, a BS or a UE device of a millimeter wave wireless technology such as fifth generation (5G) wireless (e.g., high-frequency/short wavelength spectrum, with frequencies in the range between about 20 and 60 GHZ, corresponding to wavelengths in the range between about 5 and 15 millimeters). In yet another example, the RF device 2500 may be used for wireless communications using Wi-Fi technology (e.g., a frequency band of 2.4 GHZ, corresponding to a wavelength of about 12 cm, or a frequency band of 5.8 GHZ, corresponding to a wavelength of about 5 cm). For example, the RF device 2500 may be included in a Wi-Fi-enabled device such as a desktop, a laptop, a video game console, a smart phone, a tablet, a smart TV, a digital audio player, a car, a printer, etc. In some implementations, a Wi-Fi-enabled device may be a node (e.g., a smart sensor) in a smart system configured to communicate data with other nodes. In another example, the RF device 2500 may be used for wireless communications using Bluetooth technology (e.g., a frequency band from about 2.4 to about 2.485 GHZ, corresponding to a wavelength of about 12 cm). In other embodiments, the RF device 2500 may be used for transmitting and/or receiving RF signals for purposes other than communication (e.g., in an automotive radar system, or in medical applications such as magnetic resonance imaging (MRI)).

In various embodiments, the RF device 2500 may be included in frequency-division duplex (FDD) or time-domain duplex (TDD) variants of frequency allocations that may be used in a cellular network. In an FDD system, the uplink (i.e., RF signals transmitted from the UE devices to a BS) and the downlink (i.e., RF signals transmitted from the BS to the US devices) may use separate frequency bands at the same time. In a TDD system, the uplink and the downlink may use the same frequencies but at different times.

A number of components are illustrated in FIG. 16 as included in the RF device 2500, but any one or more of these components may be omitted or duplicated, as suitable for the application. For example, in some embodiments, the RF device 2500 may be an RF device supporting both of wireless transmission and reception of RF signals (e.g., an RF transceiver), in which case it may include both the components of what is referred to herein as a transmit (TX) path and the components of what is referred to herein as a receive (RX) path. However, in other embodiments, the RF device 2500 may be an RF device supporting only wireless reception (e.g., an RF receiver), in which case it may include the components of the RX path, but not the components of the TX path; or the RF device 2500 may be an RF device supporting only wireless transmission (e.g., an RF transmitter), in which case it may include the components of the TX path, but not the components of the RX path.

In some embodiments, some or all of the components included in the RF device 2500 may be attached to one or more motherboards. In various embodiments, the RF device 2500 may not include one or more of the components illustrated in FIG. 16, but the RF device 2500 may include interface circuitry for coupling to the one or more components. For example, the RF device 2500 may not include an antenna 2502, but may include antenna interface circuitry (e.g., a matching circuitry, a connector and driver circuitry) to which an antenna 2502 may be coupled. In another set of examples, the RF device 2500 may not include a digital processing unit 2508 or a local oscillator 2506, but may include device interface circuitry (e.g., connectors and supporting circuitry) to which a digital processing unit 2508 or a local oscillator 2506 may be coupled.

As shown in FIG. 16, the RF device 2500 may include an antenna 2502, a duplexer 2504, a local oscillator 2506, and a digital processing unit 2508. As also shown in FIG. 16, the RF device 2500 may include an RX path that may include an RX path amplifier 2512 (which may be coupled to any of the antenna modules 100 disclosed herein), an RX path pre-mix filter 2514, a RX path mixer 2516, an RX path post-mix filter 2518, and an analog-to-digital converter (ADC) 2520. As further shown in FIG. 16, the RF device 2500 may include a TX path that may include a TX path amplifier 2522 (which may be coupled to any of the antenna modules 100 disclosed herein), a TX path post-mix filter 2524, a TX path mixer 2526, a TX path pre-mix filter 2528, and a digital-to-analog converter (DAC) 2530. Still further, the RF device 2500 may further include an impedance tuner 2532, an RF switch 2534, and control logic 2536. In various embodiments, the RF device 2500 may include multiple instances of any of the components shown in FIG. 16. In some embodiments, the RX path amplifier 2512, the TX path amplifier 2522, the duplexer 2504, and the RF switch 2534 may be considered to form, or be a part of, an RF front-end (FE) of the RF device 2500. In some embodiments, the RX path amplifier 2512, the TX path amplifier 2522, the duplexer 2504, and the RF switch 2534 may be considered to form, or be a part of, an RF FE of the RF device 2500. In some embodiments, the RX path mixer 2516 and the TX path mixer 2526 (possibly with their associated pre-mix and post-mix filters shown in FIG. 16) may be considered to form, or be a part of, an RF transceiver of the RF device 2500 (or of an RF receiver or an RF transmitter if only RX path or TX path components, respectively, are included in the RF device 2500). In some embodiments, the RF device 2500 may further include one or more control logic elements/circuits, shown in FIG. 16 as control logic 2536 (providing, for example, an RF FE control interface). The control logic 2536 may be used to enhance control of complex RF system environment, support implementation of envelope tracking techniques, reduce dissipated power, etc.

The antenna 2502 may be configured to wirelessly transmit and/or receive RF signals in accordance with any wireless standards or protocols, e.g., Wi-Fi, LTE, or GSM, as well as any other wireless protocols that are designated as 3G, 4G, 5G, and beyond. If the RF device 2500 is an FDD transceiver, the antenna 2502 may be configured for concurrent reception and transmission of communication signals in separate, e.g., non-overlapping and non-continuous, bands of frequencies, e.g., in bands having a separation of, e.g., 20 MHz from one another. If the RF device 2500 is a TDD transceiver, the antenna 2502 may be configured for sequential reception and transmission of communication signals in bands of frequencies that may be the same or overlapping for TX and RX paths. In some embodiments, the RF device 2500 may be a multi-band RF device, in which case the antenna 2502 may be configured for concurrent reception of signals having multiple RF components in separate frequency bands and/or configured for concurrent transmission of signals having multiple RF components in separate frequency bands. In such embodiments, the antenna 2502 may be a single wide-band antenna or a plurality of band-specific antennas (e.g., a plurality of antennas each configured to receive and/or transmit signals in a specific band of frequencies). In various embodiments, the antenna 2502 may include a plurality of antenna elements, e.g., a plurality of antenna elements forming a phased antenna array (i.e., a communication system or an array of antennas that may use a plurality of antenna elements and phase shifting to transmit and receive RF signals). Compared to a single-antenna system, a phased antenna array may offer advantages such as increased gain, ability of directional steering, and simultaneous communication. In some embodiments, the RF device 2500 may include more than one antenna 2502 to implement antenna diversity. In some such embodiments, the RF switch 2534 may be deployed to switch between different antennas.

An output of the antenna 2502 may be coupled to the input of the duplexer 2504. The duplexer 2504 may be any suitable component configured for filtering multiple signals to allow for bidirectional communication over a single path between the duplexer 2504 and the antenna 2502. The duplexer 2504 may be configured for providing RX signals to the RX path of the RF device 2500 and for receiving TX signals from the TX path of the RF device 2500.

The RF device 2500 may include one or more local oscillators 2506, configured to provide local oscillator signals that may be used for downconversion of the RF signals received by the antenna 2502 and/or upconversion of the signals to be transmitted by the antenna 2502.

The RF device 2500 may include the digital processing unit 2508, which may include one or more processing devices. In some embodiments, the digital processing unit 2508 may be implemented as the processing device 1802 of FIG. 15, descriptions of which are provided above. The digital processing unit 2508 may be configured to perform various functions related to digital processing of the RX and/or TX signals. Examples of such functions include, but are not limited to, decimation/downsampling, error correction, digital downconversion or upconversion, DC offset cancellation, automatic gain control, etc. Although not shown in FIG. 16, in some embodiments, the RF device 2500 may further include a memory device (e.g., the memory device 1804 described above with reference to FIG. 15) configured to cooperate with the digital processing unit 2508.

Turning to the details of the RX path that may be included in the RF device 2500, the RX path amplifier 2512 may include a low-noise amplifier (LNA). An input of the RX path amplifier 2512 may be coupled to an antenna port (not shown) of the antenna 2502, e.g., via the duplexer 2504. The RX path amplifier 2512 may amplify the RF signals received by the antenna 2502.

An output of the RX path amplifier 2512 may be coupled to an input of the RX path pre-mix filter 2514, which may be a harmonic or band-pass (e.g., low-pass) filter, configured to filter received RF signals that have been amplified by the RX path amplifier 2512.

An output of the RX path pre-mix filter 2514 may be coupled to an input of the RX path mixer 2516, also referred to as a downconverter. The RX path mixer 2516 may include two inputs and one output. A first input may be configured to receive the RX signals, which may be current signals, indicative of the signals received by the antenna 2502 (e.g., the first input may receive the output of the RX path pre-mix filter 2514). A second input may be configured to receive local oscillator signals from one of the local oscillators 2506. The RX path mixer 2516 may then mix the signals received at its two inputs to generate a downconverted RX signal, provided at an output of the RX path mixer 2516. As used herein, downconversion refers to a process of mixing a received RF signal with a local oscillator signal to generate a signal of a lower frequency. In particular, the RX path mixer (e.g., downconverter) 2516 may be configured to generate the sum and/or the difference frequency at the output port when two input frequencies are provided at the two input ports. In some embodiments, the RF device 2500 may implement a direct-conversion receiver (DCR), also known as homodyne, synchrodyne, or zero-intermediate frequency (IF) receiver, in which case the RX path mixer 2516 may be configured to demodulate the incoming radio signals using local oscillator signals whose frequency is identical to, or very close to the carrier frequency of the radio signal. In other embodiments, the RF device 2500 may make use of downconversion to an IF. IFs may be used in superheterodyne radio receivers, in which a received RF signal is shifted to an IF, before the final detection of the information in the received signal is done. Conversion to an IF may be useful for several reasons. For example, when several stages of filters are used, they can all be set to a fixed frequency, which makes them easier to build and to tune. In some embodiments, the RX path mixer 2516 may include several such stages of IF conversion.

Although a single RX path mixer 2516 is shown in the RX path of FIG. 16, in some embodiments, the RX path mixer 2516 may be implemented as a quadrature downconverter, in which case it would include a first RX path mixer and a second RX path mixer. The first RX path mixer may be configured for performing downconversion to generate an in-phase (I) downconverted RX signal by mixing the RX signal received by the antenna 2502 and an in-phase component of the local oscillator signal provided by the local oscillator 2506. The second RX path mixer may be configured for performing downconversion to generate a quadrature (Q) downconverted RX signal by mixing the RX signal received by the antenna 2502 and a quadrature component of the local oscillator signal provided by the local oscillator 2506 (the quadrature component is a component that is offset, in phase, from the in-phase component of the local oscillator signal by 90 degrees). The output of the first RX path mixer may be provided to a l-signal path, and the output of the second RX path mixer may be provided to a Q-signal path, which may be substantially 90 degrees out of phase with the I-signal path.

The output of the RX path mixer 2516 may, optionally, be coupled to the RX path post-mix filter 2518, which may be low-pass filters. In case the RX path mixer 2516 is a quadrature mixer that implements the first and second mixers as described above, the in-phase and quadrature components provided at the outputs of the first and second mixers respectively may be coupled to respective individual first and second RX path post-mix filters included in the RX path post-mix filter 2518.

The ADC 2520 may be configured to convert the mixed RX signals from the RX path mixer 2516 from the analog to the digital domain. The ADC 2520 may be a quadrature ADC that, similar to the RX path mixer 2516, may include two ADCs, configured to digitize the downconverted RX path signals separated in in-phase and quadrature components. The output of the ADC 2520 may be provided to the digital processing unit 2508, configured to perform various functions related to digital processing of the RX signals so that information encoded in the RX signals can be extracted.

Turning to the details of the TX path that may be included in the RF device 2500, the digital signal to later be transmitted (TX signal) by the antenna 2502 may be provided, from the digital processing unit 2508, to the DAC 2530. Similar to the ADC 2520, the DAC 2530 may include two DACs, configured to convert, respectively, digital I- and Q-path TX signal components to analog form.

Optionally, the output of the DAC 2530 may be coupled to the TX path pre-mix filter 2528, which may be a band-pass (e.g., low-pass) filter (or a pair of band-pass, e.g., low-pass, filters, in case of quadrature processing) configured to filter out, from the analog TX signals output by the DAC 2530, the signal components outside of the desired band. The digital TX signals may then be provided to the TX path mixer 2526, which may also be referred to as an upconverter. Similar to the RX path mixer 2516, the TX path mixer 2526 may include a pair of TX path mixers, for in-phase and quadrature component mixing. Similar to the first and second RX path mixers that may be included in the RX path, each of the TX path mixers of the TX path mixer 2526 may include two inputs and one output. A first input may receive the TX signal components, converted to the analog form by the respective DAC 2530, which are to be upconverted to generate RF signals to be transmitted. The first TX path mixer may generate an in-phase (I) upconverted signal by mixing the TX signal component converted to analog form by the DAC 2530 with the in-phase component of the TX path local oscillator signal provided from the local oscillator 2506 (in various embodiments, the local oscillator 2506 may include a plurality of different local oscillators, or be configured to provide different local oscillator frequencies for the RX path mixer 2516 in the RX path and the TX path mixer 2526 in the TX path). The second TX path mixer may generate a quadrature phase (Q) upconverted signal by mixing the TX signal component converted to analog form by the DAC 2530 with the quadrature component of the TX path local oscillator signal. The output of the second TX path mixer may be added to the output of the first TX path mixer to create a real RF signal. A second input of each of the TX path mixers may be coupled the local oscillator 2506.

Optionally, the RF device 2500 may include the TX path post-mix filter 2524, configured to filter the output of the TX path mixer 2526.

As noted above, the TX path amplifier 2522 may be a power amplifier, configured to amplify the upconverted RF signal before providing it to the antenna 2502 for transmission.

In various embodiments, any of the RX path pre-mix filter 2514, the RX path post-mix filter 2518, the TX path post-mix filter 2524, and the TX path pre-mix filter 2528 may be implemented as RF filters. In some embodiments, each of such RF filters may include one or more resonators (e.g., AWRs, film bulk acoustic resonators (FBARs), Lamb wave resonators, and/or contour-wave resonators), arranged in any suitable manner (e.g., in a ladder configuration). In some embodiments, an RF filter may be implemented as a plurality of RF filters, or a filter bank. A filter bank may include a plurality of RF resonators that may be coupled to a switch (e. g., the RF switch 2534) configured to selectively switch any one of the plurality of RF resonators on and off (e.g., activate any one of the plurality of RF resonators), in order to achieve desired filtering characteristics of the filter bank (e.g., in order to program the filter bank). For example, such a filter bank may be used to switch between different RF frequency ranges when the RF device 2500 is, or is included in, a BS or in a UE device. In another example, such a filter bank may be programmable to suppress TX leakage on the different duplex distances.

The impedance tuner 2532 may include any suitable circuitry, configured to match the input and output impedances of the different RF circuitries to minimize signal losses in the RF device 2500. For example, the impedance tuner 2532 may include an antenna impedance tuner. Being able to tune the impedance of the antenna 2502 may be particularly advantageous because antenna's impedance is a function of the environment that the RF device 2500 is in, e.g., antenna's impedance changes depending on, e.g., if the antenna is held in a hand, placed on a car roof, etc.

As described above, the RF switch 2534 may be a device configured to route high-frequency signals through transmission paths in order to selectively switch between a plurality of instances of any one of the components shown in FIG. 16 (e.g., to achieve desired behavior and characteristics of the RF device 2500). In some embodiments, an RF switch 2534 may be used to switch between different antennas 2502. In other embodiments, an RF switch may be used to switch between a plurality of RF resonators (e.g., by selectively switching RF resonators on and off) of any of the filters included in the RF device 2500. Typically, an RF system may include a plurality of such RF switches.

The RF device 2500 provides a simplified version and, in further embodiments, other components not specifically shown in FIG. 16 may be included. For example, the RX path of the RF device 2500 may include a current-to-voltage amplifier between the RX path mixer 2516 and the ADC 2520, which may be configured to amplify and convert the downconverted signals to voltage signals. In another example, the RX path of the RF device 2500 may include a balun transformer for generating balanced signals. In yet another example, the RF device 2500 may further include a clock generator, which may include a suitable phase-lock loop (PLL), configured to receive a reference clock signal and use it to generate a different clock signal that may then be used for timing the operation of the ADC 2520, the DAC 2530, and/or that may also be used by the local oscillator 2506 to generate the local oscillator signals to be used in the RX path or the TX path.

The following paragraphs provide examples of various ones of the embodiments disclosed herein.

Example 1 provides an antenna module that includes an IC component having a face; an antenna patch support over the face of the IC component; and a stack of antenna patches vertically arranged at least partially above one another, where a first antenna patch of the stack is an antenna patch closest to the IC component, a second antenna patch of the stack is an antenna patch closest to the first antenna patch (i.e., the second antenna patch is an antenna patch second closest to the IC component), the first antenna patch is on the face of the IC component, and the second antenna patch is on or in the antenna patch support and electrically isolated from all electrically conductive material pathways in the antenna patch support and in the IC component.

Example 2 provides the antenna module according to example 1, where the second antenna patch is an antenna patch of the stack that is closest to the first antenna patch compared to all other antenna patches of the stack.

Example 3 provides the antenna module according to examples 1 or 2, where the first antenna patch is an antenna patch of the stack that is closest to the IC component and the second antenna patch is an antenna patch of the stack that is second closest to the IC component.

Example 4 provides the antenna module according to any one of the preceding examples, further including an air cavity between the first antenna patch and the second antenna patch.

Example 5 provides the antenna module according to any one of the preceding examples, where the first antenna patch is electrically isolated from all the electrically conductive material pathways in the antenna patch support.

Example 6 provides the antenna module according to any one of the preceding examples, where no electrically conductive material pathways are present between adjacent antenna patches of the stack within a footprint of the stack.

Example 7 provides the antenna module according to any one of examples 1-6, where the antenna patch support includes a first face and a second face, the first face is opposite the second face and closer to the face of the IC component than the second face, the second antenna patch is on the first face of the antenna patch support, and an air cavity separates the first antenna patch and the second antenna patch.

Example 8 provides the antenna module according to any one of examples 1-6, where the antenna patch support includes a first face and a second face, the first face is opposite the second face and closer to the face of the IC component than the second face, the second antenna patch is in the antenna patch support or on the second face of the antenna patch support, and an air cavity separates the first antenna patch and the first face of the antenna patch support.

Example 9 provides the antenna module according to any one of the preceding examples, where the first antenna patch is part of a metallization layer of the IC component (i.e., the first antenna patch is monolithic with the IC component).

Example 10 provides the antenna module according to any one of the preceding examples, where the antenna patch support includes an antenna substrate, and the second antenna patch is on a face of the antenna substrate.

Example 11 provides the antenna module according to example 10, where the second antenna patch is attached to the face of the antenna substrate by an adhesive.

Example 12 provides the antenna module according to examples 10 or 11, where the antenna substrate is a first antenna substrate, the antenna patch support further includes a second antenna substrate, and a third antenna patch is on or in the second antenna substrate.

Example 13 provides the antenna module according to any one of the preceding examples, where the stack includes at least four antenna patches.

Example 14 provides the antenna module according to any one of the preceding examples, where the antenna patch support includes a PCB.

Example 15 provides the antenna module according to any one of the preceding examples, where the IC component includes circuitry to control operation of the antenna patches.

Example 16 provides an electronic assembly that includes a package substrate; a die having a first face and a second face opposite the first face; an antenna substrate, where the die is between the package substrate and the antenna substrate, and the first face of the die is closer to the package substrate than to the antenna substrate; a first antenna patch on the second face of the die; and a second antenna patch either in the antenna substrate or on a face of the antenna substrate, where a projection of the second antenna patch onto the package substrate at least partially overlaps with a projection of the first antenna patch onto the package substrate, and where there is no electrically continuously pathway that has one portion in electrically conductive contact with the first antenna patch and another portion in electrically conductive contact with the second antenna patch (e.g., there is no electrically continuously pathway between the first antenna patch and the second antenna patch). In a further example, no electrically conductive material pathways (or, more generally, no electrical conductors) are present between the first antenna patch and the second antenna patch.

Example 17 provides the electronic assembly according to example 16, further including interconnects between the antenna substrate and the package substrate.

Example 18 provides the electronic assembly according to examples 16 or 17, further including interconnects between the antenna substrate and the die.

Example 19 provides a communication device that includes a display; a back cover; and an antenna module between the display and the back cover, where the antenna module includes: an IC die, an antenna substrate over a face of die, and a stack of antenna patches vertically arranged at least partially above one another, where the IC die includes circuitry to control operation of the stack of antenna patches, an antenna patch of the stack that is closest to the IC die is at the face of the IC die and is in contact with one or more electrically conductive material pathways of the IC die, and an antenna patch of the stack that is second closest to the IC die is on or in the antenna substrate and is electrically isolated from the antenna patch of the stack that is closest to the IC die.

Example 20 provides the communication device according to example 19, where the first antenna patch is part of a metallization layer of the IC die.

Example 21 provides the communication device according to examples 19 or 20, where a height of the antenna module is less than 3 millimeters.

Example 22 provides the communication device according to any one of examples 19-21, where an individual antenna patch of the antenna patches is a millimeter wave antenna patch, a sub-THz antenna patch, or a THz antenna patch.

Example 23 provides the communication device according to any one of examples 19-22, where the communication device is a handheld communication device.

Example 24 provides the communication device according to any one of examples 19-23, where at least one of the one or more electrically conductive material pathways of the IC die is further connected to the circuitry.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An antenna module, comprising:
an integrated circuit (IC) component having a face;
an antenna patch support over the face of the IC component; and
a stack of antenna patches, wherein a first antenna patch of the stack is an antenna patch closest to the IC component, a second antenna patch of the stack is an antenna patch closest to the first antenna patch, the first antenna patch is on the face of the IC component, and the second antenna patch is on or in the antenna patch support and electrically isolated from all electrically conductive material pathways in the antenna patch support and in the IC component.

2. The antenna module according to claim 1, wherein the second antenna patch is an antenna patch of the stack that is closest to the first antenna patch.

3. The antenna module according to claim 1, wherein the first antenna patch is an antenna patch of the stack that is closest to the IC component and the second antenna patch is an antenna patch of the stack that is second closest to the IC component.

4. The antenna module according to claim 1, further comprising an air cavity between the first antenna patch and the second antenna patch.

5. The antenna module according to claim 1, wherein the first antenna patch is electrically isolated from all the electrically conductive material pathways in the antenna patch support.

6. The antenna module according to claim 1, wherein no electrically conductive material pathways are present between adjacent antenna patches of the stack.

7. The antenna module according to claim 1, wherein the antenna patch support includes a first face and a second face, the first face is opposite the second face and closer to the face of the IC component than the second face, the second antenna patch is on the first face of the antenna patch support, and an air cavity separates the first antenna patch and the second antenna patch.

8. The antenna module according to claim 1, wherein the antenna patch support includes a first face and a second face, the first face is opposite the second face and closer to the face of the IC component than the second face, the second antenna patch is in the antenna patch support or on the second face of the antenna patch support, and an air cavity separates the first antenna patch and the first face of the antenna patch support.

9. The antenna module according to claim 1, wherein the first antenna patch is part of a metallization layer of the IC component.

10. The antenna module according to claim 1, wherein the antenna patch support includes an antenna substrate, and the second antenna patch is on a face of the antenna substrate.

11. The antenna module according to claim 10, wherein the second antenna patch is attached to the face of the antenna substrate by an adhesive.

12. The antenna module according to claim 10, wherein the antenna substrate is a first antenna substrate, the antenna patch support further includes a second antenna substrate, and a third antenna patch is on or in the second antenna substrate.

13. The antenna module according to claim 1, wherein the stack includes at least four antenna patches.

14. The antenna module according to claim 1, wherein the antenna patch support includes a printed circuit board.

15. The antenna module according to claim 1, wherein the IC component includes circuitry to control operation of the antenna patches.

16. An electronic assembly, comprising:
a package substrate;
a die having a first face and a second face opposite the first face;
an antenna substrate, wherein the die is between the package substrate and the antenna substrate, and the first face of the die is closer to the package substrate than to the antenna substrate;
a first antenna patch on the second face of the die; and
a second antenna patch either in the antenna substrate or on a face of the antenna substrate, wherein a projection of the second antenna patch onto the package substrate at least partially overlaps with a projection of the first antenna patch onto the package substrate, and wherein there is no electrically continuously pathway that has one portion in conductive contact with the first antenna patch and another portion in conductive contact with the second antenna patch.

17. The electronic assembly according to claim 16, further comprising interconnects between the antenna substrate and the package substrate.

18. The electronic assembly according to claim 16, further comprising interconnects between the antenna substrate and the die.

19. A communication device, comprising:
a display;
a back cover; and
an antenna module between the display and the back cover, wherein the antenna module includes:
an integrated circuit (IC) die,
an antenna substrate over a face of die, and
a stack of antenna patches,
wherein the IC die includes circuitry to control operation of the stack of antenna patches, an antenna patch of the stack that is closest to the IC die is at the face of the IC die and is in contact with one or more electrically conductive material pathways of the IC die, and an antenna patch of the stack that is second closest to the IC die is on or in the antenna substrate and is electrically isolated from the antenna patch of the stack that is closest to the IC die.

20. The communication device according to claim 19, wherein at least one of the one or more electrically conductive material pathways of the IC die is further connected to the circuitry.
